(19) United States
(12) Patent Application Publication
(10) Pub. No.: US 2026/0259777 A1
(43) Pub. Date: Sep. 3, 2026

(54) Systems and Methods for Cloud Computing Resource Management

(71) Applicant: Church Bay Trust Co LTD, Hamilton (BM)

(72) Inventor: Fawad Zafar, London (GB)

(73) Assignee: Church Bay Trust Co Ltd, Hamilton (BM)

(21) Appl. No.: 18/877,661

(22) PCT Filed: Jun. 30, 2023
(86) PCT No.: PCT/EP2023/068126

§ 371 Date: Dec. 20, 2024

Related U.S. Application Data
(60) Provisional application No. 63/367,477, filed on Jun. 30, 2022.

(51) Int. Cl. G06F 9/50; G06F 21/60

(52) U.S. Cl. CPC G06F 9/5038; G06F 21/602

(57) ABSTRACT

A computing system may provide a mechanism for sharing computing resources between different cloud computing systems. A first computing system may periodically provide support in the form of computing resources to a plurality of other computing systems. A network allocation system may coordinate the computing resources to make sure that idle systems are providing computing resources to other cloud computing systems that are experiencing periods of high demand. When the first computing system is experiencing increased demand or network traffic, the network allocation system may divert computing resources from other systems to support the computational tasks that the first computing system is performing. In this way, the network allocation system may ensure efficient use of computing resources so that each computing system may perform its computing tasks in a timely manner.

### CROSS-REFERENCE TO RELATED APPLICATION(S)

This application claims the benefit of priority of U.S. Provisional Application No. 63/367,477, filed Jun. 30, 2022.

### BACKGROUND

In recent years, the implementation of cloud computing technology has increased a great deal. Cloud computing includes the delivery of computing services such as servers, storage, databases, networking, and software over the internet (“the cloud”) to offer faster innovation, flexible resources, and economies of scale. Some of the largest cloud computing services run on a worldwide network of secure datacenters, which are regularly upgraded to the latest generation of fast and efficient computing hardware. This may offer several benefits over a single corporate datacenter, including reduced network latency for applications and greater economies of scale.

### SUMMARY

Conventional cloud computing systems provide a large number of servers that can be started on demand as additional computing resources are required, for example, to address machine learning needs or an increase in network traffic, or to perform a variety of other computing tasks. However, when computing resources are not needed, conventional systems maintain a great deal of servers, databases, and other systems that are not used. This leads to a great inefficiency as the number of cloud computing system providers increases. During periods of low demand or decreased network traffic, a provider may have a number of systems that are not optimally used. On the other hand, some providers may run out of available computing resources during periods of high demand or increased network traffic.

To address these issues, methods and systems described herein may provide a mechanism for sharing computing resources between different cloud computing systems. Specifically, a first computing system may periodically provide support, in the form of computing resources, to a plurality of other computing systems. A network allocation system may coordinate the computing resources to make sure that idle systems are providing computing resources to other cloud computing systems that are experiencing periods of high demand. When the first computing system is experiencing increased demand or network traffic, the system may divert computing resources from other systems to support the computational tasks that the first computing system is performing. In this way, the network allocation system may ensure efficient use of computing resources so that each computing system may perform its computing tasks in a timely manner.

The network allocation system may further allow for multiviews and user interface interactivity and aid future planning of computing resources by providing individuals with a centralized and organized platform to manage and share computing resources between different cloud computing systems. However, providing a centralized and organized platform to manage and share computing resources between different cloud computing systems creates a fundamental technical problem in that different computing resources may be used for different types of data and/or with different functions being performed thereon. Moreover, each cloud computing system may include different individual resources including different devices, architectures, and/or preexisting commitments. To overcome these technical problems, the network allocation system may generate a hash value of standardized information related to required computing resources, time/dates of use, and/or other information used to manage and share computing resources between different cloud computing systems. Furthermore, the system may present this information, along with other information for other computing resources and/or different cloud computing systems.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for computer network resource management, in accordance with one or more embodiments.

FIG. 2 shows an illustrative diagram for an intelligence service, in accordance with one or more embodiments.

FIG. 3 shows illustrative components for a system used to determine a probability for a parametric event, in accordance with one or more embodiments.

FIG. 4 shows an example calendar view of a user interface for sharing computing resources between different cloud computing systems, in accordance with one or more embodiments.

FIG. 5 shows a flowchart for steps involved in sharing computing resources between different cloud computing systems, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

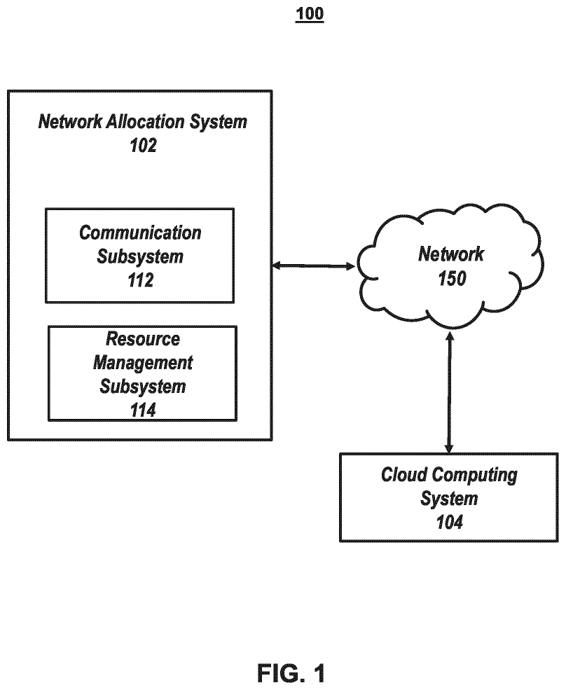

As stated above, systems and methods are described herein for novel uses and/or improvements to computing resource management. FIG. 1 shows an illustrative system 100 for managing computing resources (e.g., processing power), in accordance with one or more embodiments. The system 100 may organize the sharing of computing resources between different cloud computing systems. For example, a first computing system may periodically provide support in the form of computing resources to a plurality of other computing systems. The system 100 may coordinate (e.g., via a resource management subsystem 114 and a communication subsystem 112) the computing resources to make sure that idle systems are providing computing resources to other cloud computing systems that are experiencing periods of high demand. When the first computing system is experiencing increased demand or network traffic, the system 100 may divert computing resources from other systems to support the computational tasks that the first computing system is performing. In this way, the network allocation system may ensure efficient use of computing resources so that each computing system may perform its computing tasks in a timely manner. The amount of computing resources a computing system is able to obtain during an event of increased network traffic may be based on the amount of computing resources that the computing system provides via the system 100.

For example, FIG. 1 illustrates a network allocation system 102. The network allocation system 102 may include a communication subsystem 112 and a resource management subsystem 114. In some embodiments, the network allocation system 102 may determine a computing resource score for the cloud computing system 104. The computing resource score may indicate a likelihood that the cloud computing system 104 will need more than a threshold amount of computing power to address a computing task within a particular time period. For example, the likelihood may include a probability (e.g., an estimated probability) that usage of computing resources at the cloud computing system 104 will exceed a threshold percentage of the cloud computing system's total available computing resources.

During high demand events (e.g., when computing resource usage is above a threshold level), the network allocation system 102 may allocate additional computing resources for the cloud computing system 104. To increase capacity, the network allocation system 102 may divert one or more tasks or requests to perform a task from the cloud computing system 104 to a third-party cloud computing system.

In some embodiments, the system 100 may assist with allocating financial resources to users or entities (e.g., policyholders) associated with the system 100. For example, the network allocation system 102 may be a Modular Automated Prudential Insurance (MAP) system that is configured to provide insurance for financial technology applications (e.g., blockchain related technology, cryptocurrencies, stable coins, etc.). The network allocation system 102 may provide or allocate financial resources (e.g., fiat money, digital assets including a variety of cryptocurrencies, etc.) to computing devices, users, or organizations based on one or more events (e.g., parametric events) that have occurred. The network congestion discussed above may include a financial loss associated with a computing device, a user, or an organization. For example, the network allocation system 102 may allow for the allocation of premiums in fiat and digital assets with hashed parametric events issuing payments on policies. In some embodiments, the network allocation system 102 may provide a credit score (e.g., Z-Score) for regulators and trade credit/finance companies to allow prudential assurance, underwriting, and factoring to help prevent cross-border insolvency.

Traditional insurance has two cost categories; first is the underlying risk that is being insured and, second, the costs involved in operating the insurance, such as carrying out individual risk assessments and loss adjustments. The network allocation system 102 may provide resources to ensure adequate financial or computing resources are attainable. The network allocation system 102 may implement a MAP index, for example, that may be used to determine how to allocate financial or computing resources.

In some embodiments, the MAP index may be used by the network allocation system 102 to determine an amount of computing resources (e.g., processing power) that should be received from a computing device. A computing device may periodically provide computing resources to the network allocation system 102 to allow a variety of computing tasks associated with other devices to be performed. For example, a user device may need to train a machine learning model and may use the network allocation system 102 to allocate computing resources to the machine learning task. By doing so, the user device may complete the task more quickly. In return, the user device may provide some of its own computing power when needed by other devices for other computing tasks. In this way, the computing resources may be shared between a variety of devices as needed and may increase efficiency for completing computing tasks because otherwise idle computing devices may share their computing resources to complete more urgent tasks. When the computing device needs to perform a task, the network allocation system may provide computing resources from other devices to the computing device to allow the task to be completed more quickly.

In some embodiments, the MAP index may be used by the network allocation system 102 to determine allocations of financial resources. The network allocation system 102 may provide resources for the coverage of political and commercial risk to help prevent cross-border insolvency. The network allocation system 102 may implement a MAP index. The MAP index may be software (e.g., one or more functions, modules, etc.) that allows the allocation of premiums and insurance policies to be paid with any currency, fiat money, or digital asset and underwrites the indices of digital registrars. As described herein, a digital asset may include anything that is stored digitally and is uniquely identifiable that users or organizations can use. A digital asset may include cryptocurrencies, such as bitcoin, stable coins, non-fungible tokens (NFTs), or a variety of other digital assets.

In some embodiments, the MAP index may be generated (e.g., by the network allocation system 102) based on a variety of content items such as contracts, e.g., invoices, purchase orders, bills of lading, self-executing programs (e.g., smart contracts), or the like. In building the MAP index from contracts, the network allocation system 102 may use the example of invoices applying VAT/GST/excise/sales tax as proxy and any tax liability that is recorded on digital registrars.

In some embodiments, the network allocation system 102 may use natural language processing techniques and machine learning to retrieve information from the content items. For example, the retrieved information may be used as input into the MAP index and may be used to determine an amount of computing resources that should be received from the cloud computing system 104 each month, such that a threshold amount of computing resources may be provided to the cloud computing system 104 if a parametric event occurs (e.g., if the user device needs to have a machine learning model trained using a threshold amount of computing resources). For example, in some embodiments, a parametric event may refer to parametric insurance (also called index-based insurance) that offers pre-specified payouts based upon a trigger event. Trigger events may depend on the nature of the parametric policy and can include environmental triggers such as wind speed and rainfall measurements, business-related triggers such as foot traffic, and more. For example, a parametric policy may utilize a payout per metric of coverage with discreet metrics redeemable for a specified amount in the event of a loss.

In some embodiments, the network allocation system 102 may use the MAP index to determine a premium for an insurance product described herein. In one example, the network allocation system 102 may determine a premium as follows:

$$Premium ( j ) = j \times premium structure ( j )$$

Where j=invoice amount band

In some embodiments, the network allocation system 102 may use the MAP index to determine claims in digital assets or fiat currencies. For example, the claim numbers, expected claim amount, or total risk exposure may be determined as follows:

$$Expected Claim amount ( j ) = Claim Coverage ( VAT proxy ) \% \times invoice amount ( j )$$

$$Total Risk Exposure = {\sum }_{All j} Claim numbers ( j ) \times Expected claim amount ( j )$$

Where j=invoice amount band; q=quarter

In some embodiments, the network allocation system 102 may use the MAP index to determine a claim's fee cover in digital assets or fiat currencies. For example, the network allocation system 102 may determine claim numbers, total claim incidents, or total risk exposure as follows:

$$Claim numbers ( j ) = Probability ( p ) of claim \times Proportion of clients ( j ) \times total clients ( q )$$

$$Total claim incidents = {\sum }_{All j} Claim numbers ( j )$$

$$Expected Claim amount ( j ) = 100$$

$$Total Risk Exposure = {\sum }_{All j} Claim numbers ( j ) \times Expected claim amount ( j )$$

Where j=invoice amount band; q=quarter

In some embodiments, the network allocation system 102 may use the MAP index to determine how to allocate resources for political and commercial risks. The network allocation system 102 may code the operation of the policy with parametric events to allow automatic payments to policyholders that are registered on digital registrars. For example, the network allocation system 102 may use information retrieved from the content items described above to determine a premium that should be paid so that a threshold amount of financial resources may be provided if a parametric event occurs (e.g., if the value of a particular cryptocurrency falls beneath a threshold amount).

The network allocation system 102 may use a variety of risk management structures to help with resource allocation. The network resource system may allocate resources by processing claims that request computing resources or financial resources. In some embodiments, a risk management structure may include an excess of loss event. The network allocation system 102 may use an excess of loss methodology to limit the total amount of resources (e.g., financial resources or computing resources) that is provided to any one policyholder. A policyholder may include a user, an organization, a computing device, or a variety of other devices or entities. For example, the network allocation system 102 may allocate resources for an excess of loss event by determining an expected claim covered or a total risk exposure as follows:

$$Expected Claim Covered ( j ) = Max [ Claim Coverage ( VAT proxy ) \% \times invoice amount ( j ) , x ]$$

$$Total Risk Exposure = {\sum }_{All j} Claim numbers ( j ) \times Expected claim amount ( j )$$

In some embodiments, a risk management structure may include a proportional loss event. For a proportional loss event, the network allocation system 102 may provide a proportion (e.g., a percentage) of an amount of resources requested in a claim. For example, if a parametric event occurs, the network allocation system 102 may provide resources up to 20% of an associated claim. In one example, the network allocation system may allocate resources for a proportional loss event by determining an expected claim covered or a total risk exposure as follows:

$$Expected Claim Covered ( j ) = Cover \% ( c ) \times [ Claim Coverage ( VAT proxy ) \% \times invoice amount ( j ) ]$$

$$Total Risk Exposure = {\sum }_{All j} Claim numbers ( j ) \times Expected claim amount ( j )$$

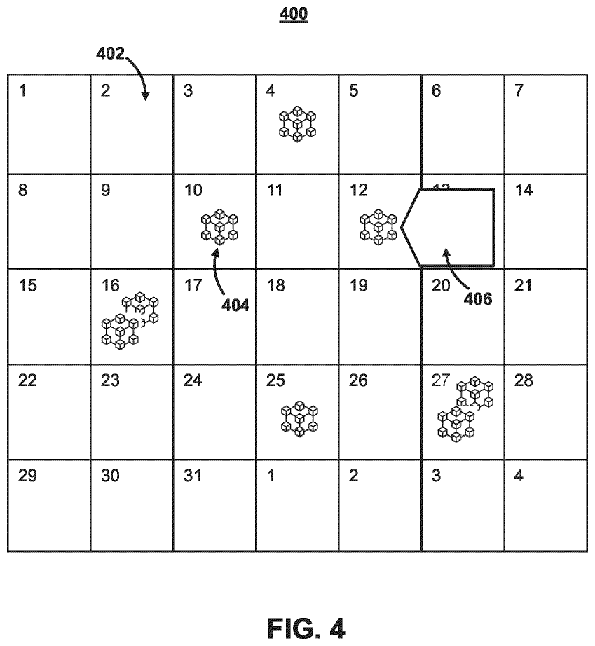

In some embodiments, the network allocation system 102 or the cloud computing system 104 may provide a graphical user interface (GUI) associated with the functionality described above. The GUI may provide a calendar view. An example calendar view as shown in FIG. 4. For example, a user may be able to click on a button to create a new invoice that is added to the MAP index. Each cell in the calendar view may act as a button to create a new invoice. For example, by interacting with a cell, a new invoice may be created. Interacting with a button may open up a dialog with a form that the user may fill out with all of the relevant data that can be used to create the invoice. For example, the relevant data may include a name, address, a total amount of premium needed for coverage, a due date, or an indication of one or more products (e.g., for each product, an indication of name, quantity, and price may be required). To confirm creation of the invoice, the network allocation system 102 or the cloud computing system 104 may provide a button that a user may interact with.

Based on receiving an interaction with the button, the network allocation system 102 may send data to a function (e.g., a Lambda function) for processing. The network allocation system 102 may generate a code (e.g., a unique MAP code) and may hash the time when the premium payment is paid in fiat or with a digital asset. The network allocation system 102 may generate a document that includes the invoice with its MAP code. The network allocation system 102 may store the document in a container (e.g., located on a server or other computing device that is accessible via a network). The network allocation system may hash a variety of data associated with the MAP Insurance around premium, and event data is then hashed into a blockchain database (e.g., a quantum ledger database (QLDB)). The data may be converted into a blockchain database stream and into a data streaming service stream (e.g., a Kenisis stream). A function (e.g., a Lambda function) may receive and process this data and may update a database (e.g., DynamoDB) accordingly. The network allocation system 102 may use the MAP index to automatically share a MAP score with a digital registrar.

The network allocation system 102 may generate a MAP score. The MAP score may create a real-time credit scoring for calculating the probability of default, insurance policy pricing, and factoring. A MAP score may be calculated via the MAP index based on the tax filings through digital registers, which allows the MAP score to be location-specific with digital registrars and filings. Underwriting for deposit reserve on digital assets and commodities through the MAP index allows for solvency and liquidity ratios through MAP scores to highlight the continuity of service for registrants in digital registrars.

A MAP index credit score may range from 300 to 850 and may allow access to trade finance and to carry financial history across borders to help prevent cross-border insolvency. MAP index may allow for a credit score to be applied to trade credit, trade finance, global minimum corporate tax, digital taxes, payroll taxes, and other taxes agreed upon by states.

The credit score described above may allow access to trade finance associated with blockchain technology or any blockchain activity described below. In some embodiments, the systems and methods described above may relate to providing insurance for blockchain activities, users/entities involved in blockchain activities, a nature or scope of a blockchain activity, and/or any other information related to one or more blockchain activities.

As referred to herein, “a blockchain activity” may comprise any activity including and/or related to blockchains and blockchain technology. For example, blockchain activities may include conducting transactions, querying a distributed ledger, generating additional blocks for a blockchain, transmitting communications-related NFTs, performing encryption/decryption, exchanging public/private keys, and/or other activities related to blockchains and blockchain technology. In some embodiments, a blockchain activity may comprise the creation, modification, detection, and/or execution of a smart contract or program stored on a blockchain. In some embodiments, a blockchain activity may comprise the creation, modification, exchange, and/or review of a token (e.g., a digital blockchain-specific asset), including a non-fungible token. A non-fungible token may comprise a token that is associated with a good, a service, a smart contract, and/or other content that may be verified by, and stored using, blockchain technology. As referred to herein, “content” should be understood to mean an electronically consumable user asset, representations of goods or services (including NFTs), internet content (e.g., streaming content, downloadable content, webcasts, etc.), video data, audio data, image data, and/or textual data, etc.

The system may determine probabilities for parametric events (e.g., as described above) by monitoring, determining, and/or facilitating discovery of users/entities involved in blockchain activities. It should be further noted that many embodiments rely on implementation involving both blockchain technology as well as artificial intelligence. As referred to herein, artificial intelligence (or simply “intelligence”) may include machine learning, deep learning, computer learning and/or other techniques. Furthermore, artificial intelligence models (or simply “models”) may include machine learning models, deep learning models, etc. Artificial intelligence inputs and outputs may include static metadata and metatags or automatically updated metadata and metatags by artificial intelligence.

For example, determining probabilities for parametric events may include a combination of collecting and analyzing a variety of data related to, or informative of, one or more blockchain activities. For example, determining probabilities for parametric events, as described herein, may enable the network allocation system 102 (e.g., via the MAP index) to comply with local and global regulations (e.g., related to insurance) and to reduce manual work processes.

The systems and methods that determine probabilities for parametric events may further generate recommendations and/or visualizations on a user interface. For example, the system may generate (or generate for display on a device) a recommendation that may provide an option to perform an action or not perform an action (e.g., provide insurance or not based on a credit score described above), determine a likelihood of loss in relation to blockchain activity, and/or may provide an estimate for premiums to charge for insurance for blockchain related activity. In another example, the system may generate (or generate for display on a device) a visualization of probabilities for parametric events through an intuitive interface that may provide insights into a blockchain activity or insurance. For example, the system may determine a plurality of events (e.g., corresponding to invoices for goods and/or services, computing resource requirements, etc.), and the system may then notify a user with information related to the events (e.g., as shown in FIG. 4 below).

In some embodiments, the system may receive and/or generate for display events, information about events, in a user interface. As referred to herein, a “user interface” may comprise a mechanism for human-computer interaction and communication in a device and may include display screens, keyboards, a mouse, and the appearance of a desktop. For example, a user interface may comprise a way a user interacts with an application or website in order to submit an invoice, process a claim (e.g., as described above), determine a probability for a parametric event, or generate a credit score for an entity (e.g., as described above).

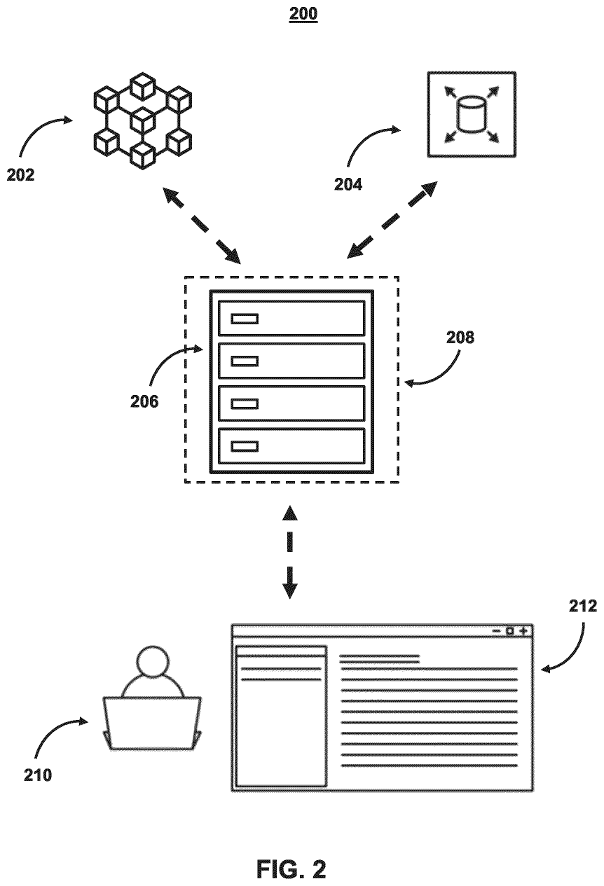

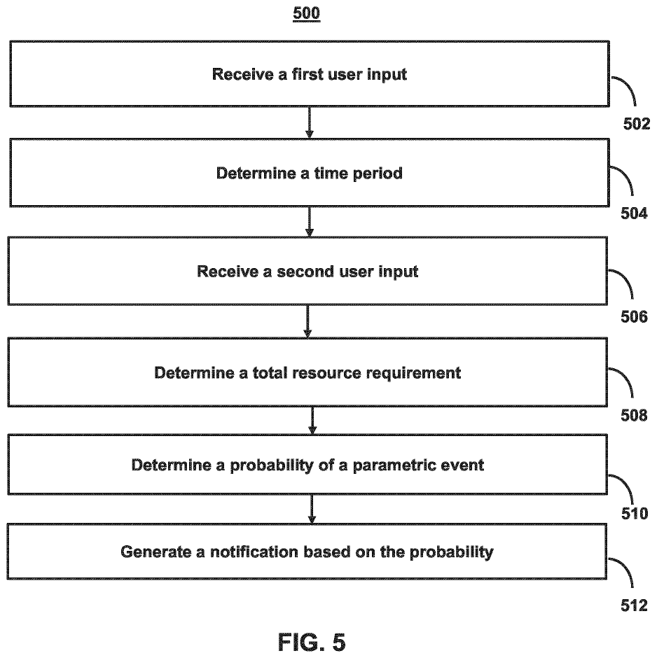

FIG. 2 shows an illustrative diagram for a blockchain intelligence service that may be used in accordance with one or more embodiments. For example, in some embodiments, the system may use system 200 to determine a probability for a parametric event, determine premium amounts for insurance related to blockchain technology, or determine a credit score for a user or entity. System 200 may fetch raw data (e.g., data related to a current state and/or instance of blockchain 202) from a node of a blockchain network (e.g., as described above). System 200 may alternatively or additionally fetch raw data (e.g., data related to other information) from data source 204 (e.g., a non-blockchain source). The system may monitor and track information from multiple data sources to develop a user and/or entity profile (e.g., to determine a credit score for the user or entity). For example, system 200 may provide and/or otherwise facilitate network allocation system 400 (FIG. 4) and/or process 500 (FIG. 5).

The system may monitor content generated by the user to generate user profile data. As referred to herein, “an entity profile” and/or “entity profile data” may comprise data actively and/or passively collected about an entity. For example, the entity profile data may comprise content generated by the entity and an entity characteristic for the entity. An entity profile may be content consumed and/or created by an entity.

Entity profile data may also include an entity characteristic. As referred to herein, “an entity characteristic” may include information about an entity and/or information included in a directory of stored entity settings, preferences, and information for the entity. For example, information about an entity may include historical data on blockchain activities. Additionally or alternatively, the information may include information about entities potentially linked to another entity. For example, an entity profile may have information about the settings for installed programs and operating system, social media information and/or accounts, financial records, etc. In some embodiments, the entity profile may be a visual display of personal data associated with a specific entity. In some embodiments, the entity profile may be digital representation of an entity's identity. The data in the entity profile may be generated based on the system actively or passively monitoring.

System 200 may then process the data and store it in a database and/or data structure in an efficient way to provide quick access to the data. For example, data source 206 may publish and/or record a subset of blockchain activities that occur for blockchain 202. Accordingly, for subsequent blockchain activities, system 200 may reference the index at data source 204 as opposed to a node of blockchain 202 to provide various services at user device 210.

For example, data source 206 may store a predetermined list of blockchain activities to monitor for and/or record in an index (e.g., the MAP index described above in connection with FIG. 1). These may include blockchain activities (e.g., “operation included,” “operation removed,” “operation finalized”) related to a given type of blockchain activity (e.g., “transaction,” “external transfer,” “internal transfer,” “new contract metadata,” “ownership change,” etc.) as well as blockchain activities related to a given protocol, protocol subgroup, and/or other characteristic (e.g., “ETH,” “ERC20,” and/or “ERC721”). Additionally and/or alternatively, the various blockchain activities and metadata related to those blockchain activities (e.g., block designations, user accounts, time stamps, etc.) as well as an aggregate of multiple blockchain activities (e.g., total blockchain activities amounts, rates of blockchain activities, rate of blockchain updates, etc.) may be monitored and/or recorded. In some embodiments, the blockchain activity may comprise a parametric event and/or other information used to generate a notification (e.g., notification 404 (FIG. 4)) to a user.

System 200 may also include layer 208, which may comprise one or more APIs and/or Application Binary Interfaces (ABIs). In some embodiments, layer 208 may be implemented on user interface 402. Alternatively or additionally, layer 208 may reside on one or more cloud components. For example, layer 208 may reside on a server and comprise a platform service for a custodial wallet service, decentralized application, etc. Layer 208 (which may be a REST or web services API layer) may provide a decoupled interface to data and/or functionality of one or more applications.

Layer 208 may provide various low-level and/or blockchain-specific operations in order to determine a probability for a parametric event, determine premium amounts for insurance related to blockchain technology, or determine a credit score for a user or entity. For example, layer 208 may provide blockchain activities such as blockchain writes. Furthermore, layer 208 may perform a transfer validation ahead of forwarding the blockchain activity (e.g., a transaction) to another service (e.g., a crypto service). Layer 208 may then log the outcome. For example, by logging to the blockchain prior to forwarding, the layer 208 may maintain internal records and balances without relying on external verification.

Layer 208 may also provide informational reads. For example, layer 208 (or a platform service powered by layer 208) may generate blockchain activity logs and write to an additional ledger (e.g., an internal record and/or indexer service) the outcome of the reads. If this is done, a user accessing the information through other means may see consistent information such that downstream users ingest the same data point as the user.

Layer 208 may also provide a unified API to access balances, transaction histories, and/or other blockchain activity records between one or more decentralized applications and custodial user accounts. By doing so, the system maintains the security of sensitive information such as the balances and transaction history. Alternatively, a mechanism for maintaining such security would separate the API access between the decentralized applications and custodial user accounts through the use of special logic. The introduction of the special logic decreases the streamlining of the system, which may result in system errors based on divergence and reconciliation.

Layer 208 may provide a common, language-agnostic way of interacting with an application. In some embodiments, layer 208 may comprise a web services API that offers a well-defined contract that describes the services in terms of their operations and the data types used to exchange information. REST APIs do not typically have this contract; instead, they are documented with client libraries for most common languages including Ruby, Java, PHP, and JavaScript. SOAP web services have traditionally been adopted in the enterprise for publishing internal services as well as for exchanging information with partners in business-to-business (B2B) transactions.

Layer 208 may use various architectural arrangements. For example, system 200 may be partially based on layer 208, such that there is strong adoption of SOAP and RESTful web services, using resources such as Service Repository and Developer Portal, but with low governance, standardization, and separation of concerns. Alternatively, system 200 may be fully based on layer 208, such that separation of concerns between layers such as layer 208, services, and applications are in place.

In some embodiments, the system architecture may use a microservice approach. Such systems may use two types of layers: front-end layers and back-end layers, where microservices reside. In this kind of architecture, the role of the layer 208 may be to provide integration between front-end and back-end layers. In such cases, layer 208 may use RESTful APIs (exposition to front-end or even communication between microservices). Layer 208 may use the Advanced Message Queuing Protocol (AMQP), which is an open standard for passing business messages between applications or organizations. Layer 208 may use an open-source, high-performance remote procedure call (RPC) framework that may run in a decentralized application environment. In some embodiments, the system architecture may use an open API approach. In such cases, layer 208 may use commercial or open-source API platforms and their modules. Layer 208 may use a developer portal. Layer 208 may use strong security constraints applying a web application firewall that protects the decentralized applications and/or layer 208 against common web exploits, bots, and denial-of-service (DDoS) attacks. Layer 208 may use RESTful APIs as standard for external integration.

As shown in FIG. 2, system 200 may use layer 208 to communicate with and/or facilitate blockchain activities with user device 210 and/or other components. In some embodiments, the system may also use one or more ABIs. An ABI is an interface between two program modules, often between operating systems and user programs. ABIs may be specific to a blockchain protocol. For example, an Ethereum Virtual Machine (EVM) is a core component of the Ethereum network, and a smart contract may be a piece of code stored on the Ethereum blockchain, which is executed on EVM. Self-executing programs (e.g., smart contracts) written in high-level languages like Solidity or Vyper may be compiled in EVM executable bytecode by the system. Upon deployment of the smart contract, the bytecode is stored on the blockchain and is associated with an address. To access functions defined in high-level languages, the system translates names and arguments into byte representations for byte code to work with it. To interpret the bytes sent in response, the system converts back to the tuple (e.g., a finite ordered list of elements) of return values defined in higher-level languages. Languages that compile for the EVM maintain strict conventions about these conversions, but in order to perform them, the system must maintain the precise names and types associated with the operations. The ABI documents these names and types precisely in an easily parseable format, doing translations between human-intended method calls and smart-contract operations that are discoverable and reliable.

For example, ABI defines the methods and structures used to interact with the binary contract similar to an API, but on a lower level. The ABI indicates the caller of the function to encode (e.g., ABI encoding) the needed information, like function signatures and variable declarations in a format so that the EVM can understand what to call that function in bytecode. ABI encoding may be automated by the system using compilers or wallets interacting with the blockchain.

As shown in FIG. 2, system 200 may include one or more user devices (e.g., user device 210). For example, system 200 may comprise a distributed state machine, in which each of the components in FIG. 2 acts as a client of system 200. For example, system 200 (as well as other systems described herein) may comprise a large data structure that holds not only all accounts and balances but also a state machine, which can change from block to block according to a predefined set of rules and which can execute arbitrary machine code. The specific rules of changing state from block to block may be maintained by a virtual machine (e.g., a computer file implemented on and/or accessible by a user device, which behaves like an actual computer) for the system.

It should be noted that user device 210 may comprise any type of computing device, including, but not limited to, a laptop computer, a tablet computer, a hand-held computer, and/or other computing equipment (e.g., a server), including “smart,” wireless, wearable, and/or mobile devices. It should be noted that embodiments describing system 200 performing a blockchain activity may equally be applied to, and correspond to, an individual user device (e.g., user device 210) performing the blockchain activity. That is, system 200 may correspond to a user device (e.g., user device 210) collectively or individually.

In some embodiments, system 200 may represent a decentralized application environment. A decentralized application may comprise an application that exists on a blockchain (e.g., blockchain 202) and/or a peer-to-peer network. That is, a decentralized application may comprise an application that has a back end that is in part powered by a decentralized peer-to-peer network such as a decentralized, open-source blockchain with smart-contract functionality.

For example, the network may allow user devices (e.g., user device 210) within the network to share files and access. In particular, the peer-to-peer architecture of the network allows blockchain activities (e.g., corresponding to blockchain 202) to be conducted between the user devices in the network, without the need of any intermediaries or central authorities.

In some embodiments, the user devices of system 200 may comprise one or more cloud components. For example, cloud components may be implemented as a cloud computing system and may feature one or more component devices. It should also be noted that system 200 is not limited to one user device (e.g., user device 210). Users may, for instance, utilize one or more devices to interact with one another, one or more servers, or other components of system 200. It should be further noted that while one or more operations (e.g., blockchain activities) are described herein as being performed by a particular component (e.g., user device 210) of system 200, those operations may, in some embodiments, be performed by other components of system 200. As an example, while one or more operations are described herein as being performed by components of user device 210, those operations may, in some embodiments, be performed by one or more cloud components. In some embodiments, the various computers and systems described herein may include one or more computing devices that are programmed to perform the described functions. Additionally, or alternatively, multiple users may interact with system 200 and/or one or more components of system 200.

With respect to the components of system 200, each of these devices may receive content and data via input/output (hereinafter “I/O”) paths using I/O circuitry. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display such as user interface 212) for use in receiving and displaying data.

Additionally, the devices in system 200 may run an application (or another suitable program). The application may cause the processors and/or control circuitry to perform operations related to determining a probability for a parametric event, determining premium amounts for insurance related to blockchain technology, or determining a credit score for a user or entity, for example, within a decentralized application environment.

Each of these devices may also include electronic storages. The electronic storages may include non-transitory storage media that electronically stores information. The electronic storage media of the electronic storages may include one or both of (i) system storage that is provided integrally (e.g., is substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more optically readable storage media (e.g., optical disk, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

System 200 may also use one or more communication paths between devices and/or components as shown in FIG. 2. The communication paths may include the internet, a mobile phone network, a mobile voice or data network (e.g., a 5G or LTE network), a cable network, a public switched telephone network, or other types of communication networks or combinations of communication networks. The communication paths may separately or together include one or more communication paths, such as a satellite path, a fiber-optic path, a cable path, a path that supports internet communications (e.g., IPTV), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices.

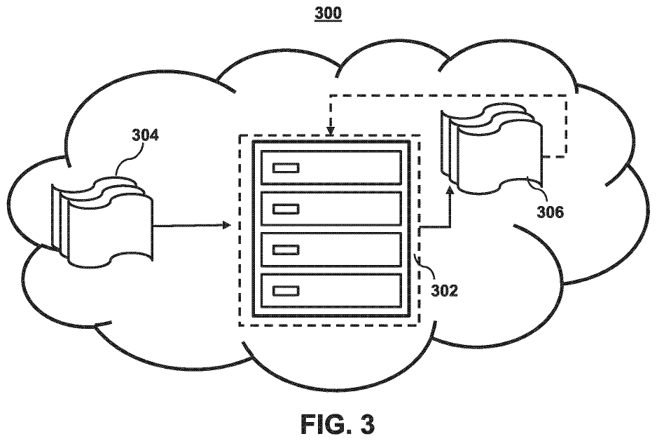

FIG. 3 shows illustrative components for a system used to determine a probability for a parametric event, determine premium amounts for insurance related to blockchain technology, or determine a credit score for a user or entity, in accordance with one or more embodiments. System 300 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., to determine a probability for a parametric event, determine premium amounts for insurance related to blockchain technology, or determine a credit score for a user or entity.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a classification that indicates a credit score for a user or entity.).

In some embodiments, the model (e.g., model 302) may automatically perform actions based on outputs 306. In some embodiments, the model (e.g., model 302) may not perform any actions. The output of the model (e.g., model 302) may be used to determine a probability for a parametric event, determine premium amounts for insurance related to blockchain technology, or determine a credit score for a user or entity.

FIG. 4 shows an example calendar view of a user interface for sharing computing resources between different cloud computing systems, in accordance with one or more embodiments. In some embodiments, the network allocation system 400 may use the MAP index to determine a network allocation for computing resources, insurance products (as described herein), and/or any other good or service. In one example, the network allocation system 400 may determine a network allocation as follows:

$$Network allocation ( j ) = j \times network allocation structure ( j )$$

Where j=event amount band

In some embodiments, the network allocation system 400 may use the MAP index to determine resource requirements in terms of storage capacity, processing requirements, and/or another metric that indicates a qualitative or quantitative unit. For example, resource requirements may be defined by a metric such as availability, response time, channel capacity, latency, completion time, service time, bandwidth, throughput, relative efficiency, scalability, performance per watt, compression ratio, instruction path length, and/or speedup. For example, the resource requirement numbers, expected resource requirement amount, and/or total risk exposure may be determined as follows:

$$Expected Resource Requirement Amount ( j ) = Resource Requirement Coverage ( metric ) \% \times event amount ( j )$$

$$Total Risk Exposure = {\sum }_{All j} Resource requirement numbers ( j ) \times Expected Resource Requirement Amount ( j )$$

Where j=event amount band

In some embodiments, the network allocation system 400 may use the MAP index to determine resource requirements in a selected metric. For example, the network allocation system 400 may determine resource requirement numbers, total resource requirement incidents, or total risk exposure as follows:

$$Resource Requirement Numbers ( j ) = Probability ( p ) of Resource Requirement \times Proportion of Computing Resources ( j ) \times Total Computing Resources ( q )$$

$$Total Resource Requirement Incidents = {\sum }_{All j} Resource Requirement Numbers ( j )$$

$$Expected Resource Requirement Amount ( j ) = 100$$

$$Total Risk Exposure = {\sum }_{All j} Resource Requirement Numbers ( j ) \times Expected Resource Requirement Amount ( j )$$

Where j=event amount band; q=quarter

In some embodiments, the network allocation system 400 may use the MAP index to determine how to allocate resources for political and commercial risks. The network allocation system 400 may code (e.g., via a hashed metric) the operation of the policy with parametric events to allow automatic notification (e.g., notification 404) to users who are registered to receive user interface 402.

A notification may be presented in user interface 402 to represent particular computing resources required at a given time/date, a potential occurrence of a parametric event (e.g., a potential for available computing resources to fall beneath a threshold amount, etc.). For example, the network allocation system 400 may use information retrieved from the computing resource requirements, entity profile to determine a network allocation that should be allocated so that a threshold amount of computing resources may be provided if a parametric event occurs (e.g., if available computing resources falls beneath a threshold amount).

In some embodiments, a notification (e.g., notification 404) may be selected by a user. In response, user interface 402 may present additional information 406. For example, additional information 406 may present a likelihood of a parametric event, information about a notification, information about computing resources used, etc. For example, user interface 402 may generate notifications (e.g., notification 404) based on a plurality of events describing computing resources requirements and/or information about those requirements. In some embodiments, the event may include information (e.g., additional information 406) about a client name, address (e.g., shipping address, street, city, state, ZIP Code, etc.), a total amount of computing resources needed for coverage, due dates, products (e.g., devices, applications, etc.), or additional information about a good or service related to the computing resources (e.g., names, metrics, prices, etc.).

The network allocation system 400 may use a variety of risk management structures to help with resource allocation. The network resource system may allocate resources by processing resource requirements that request computing resources or financial resources. In some embodiments, a risk management structure may include an excess of loss event (e.g., a network crash, lack of available resources, etc.). The network allocation system 400 may use an excess of loss methodology to limit the total amount of resources (e.g., computing resources) that is provided to any one user. A user may include a user, an organization, a computing device, or a variety of other devices or entities. For example, the network allocation system 400 may allocate resources for an excess of loss event by determining an expected resource requirement covered or a total risk exposure as follows:

$$Expected Resource Requirement Covered ( j ) = Max [ Resource Requirement Coverage ( metric ) \% \times event amount ( j ) , x ]$$

$$Total Risk Exposure = {\sum }_{All j} Resource Requirement Numbers ( j ) \times Expected Resource Requirement Amount ( j )$$

In some embodiments, a risk management structure may include a proportional loss event. For a proportional loss event, the network allocation system 400 may provide a proportion (e.g., a percentage) of an amount of resources requested in a resource requirement. For example, if a parametric event occurs, the network allocation system 400 may provide resources up to 20% of an associated resource requirement. In one example, the network allocation system may allocate resources for a proportional loss event by determining an expected resource requirement covered or a total risk exposure as follows:

$$Expected Resource Requirement Covered ( j ) = Cover \% ( c ) \times [ Resource Requirement Coverage ( metic ) \% \times event amount ( j ) ]$$

$$Total Risk Exposure = {\sum }_{All j} Resource Requirement Numbers ( j ) \times Expected Resource Requirement Amount ( j )$$

FIG. 5 shows a flowchart for steps involved in sharing computing resources between different cloud computing systems, in accordance with one or more embodiments. For example, a process may be used by a network allocation system to organize the sharing of computing resources between different cloud computing systems. For example, a first computing system may periodically provide support in the form of computing resources to a plurality of other computing systems. The system may coordinate the computing resources to make sure that idle systems are providing computing resources to other cloud computing systems that are experiencing periods of high demand.

When the first computing system is experiencing increased demand or network traffic, the system may divert computing resources from other systems to support the computational tasks that the first computing system is performing. In this way, the network allocation system may ensure efficient use of computing resources so that each computing system may perform their computing tasks in a timely manner. The amount of computing resources a computing system is able to obtain during an event of increased network traffic may be based on the amount of computing resources that the computing system provides via the system.

In some embodiments, the system may determine a computing resource score for the cloud computing system. The computing resource score may indicate a likelihood that the cloud computing system will need more than a threshold amount of computing power to address a computing task within a particular time period. For example, the likelihood may include a probability (e.g., an estimated probability) that usage of computing resources at the cloud computing system will exceed a threshold percentage of the cloud computing system's total available computing resources. That is, the system may determine a parametric event.

During high demand events (e.g., when computing resource usage is above a threshold level), the system may allocate additional computing resources for the cloud computing system. To increase capacity, the system may divert one or more tasks or requests to perform a task from the cloud computing system to a third party cloud computing system and/or other supplemental cloud resource.

At step 502, process 500 (e.g., using one or more components described above) receives a first user input. For example, the system may receive, via a user interface, a first user input, wherein the first user input schedules a first event. For example, the system may receive a user input creating a new invoice and/or event.

In some embodiments, the first user input may be received via a user interface. For example, the scheduling graphic may comprise a calendar view and/or other organizational tool. For example, the system may generate for display a scheduling graphic in the user interface, wherein the scheduling graphic comprises a plurality of time periods. The system may then receive a third user input, wherein the third user input comprises first event data, wherein the time period corresponding to the first event is based on the first event data. For example, the event data may comprise information related to the event, such as computing resources needed, computing resource structure (e.g., terms of use of the computing resource including required/threshold metrics such as availability, response time, channel capacity, latency, completion time, service time, bandwidth, throughput, relative efficiency, scalability, performance per watt, compression ratio, instruction path length, and/or speedup).

At step 504, process 500 (e.g., using one or more components described above) determines a time period. For example, the system may determine a time period corresponding to the first event. For example, the time period may comprise a date or time (or range thereof). For example, the system may receive a plurality of events corresponding to the time period. The system may determine respective resource requirements based on the plurality of events. The system may determine the threshold probability based on the respective resource requirements.

At step 506, process 500 (e.g., using one or more components described above) receives a second user input. For example, the system may receive a second user input, wherein the second user input indicates first resource requirement for the first event. For example, the system may receive user inputs providing specific details about an event. The details may comprise resource requirements (e.g., in a computing resource embodiment) or premiums, payouts, etc., in an insurance embodiment. For example, the system may determine a specific taxonomy used to describe the event in its native format. The system may then convert this to a standardized format. For example, the system may receive a second event of a plurality of events. The system may determine a first taxonomy for the second event. The system may determine second event data based on the first taxonomy. The system may then determine a second taxonomy for the second event, wherein the second taxonomy is a standardized taxonomy. The system may then reformat second event data based on the second taxonomy.

In some embodiments, the system may store one or more characteristics of an event and/or event data using a hashing algorithm. For example, the system may generate a first hash based on the first event. The system may record the first hash on a first blockchain. The resulting hash value is represented as a sequence of characters or binary digits. As described herein, a hashing algorithm may be a mathematical function that takes an input (often referred to as the “message” or “data”) and produces a fixed-size output, which is called the hash or hash value. To generate the hash, the system may receive an input message that is prepared to ensure consistent and reliable hashing. This may involve converting the message into a specific format or applying padding rules if necessary. For example, receiving the first hash of the plurality of hashes from the first blockchain network may comprise determining an encryption for the first hash and decrypting the first hash based on the encryption.

The system may perform this because the results are deterministic (e.g., for the same input message, the hashing algorithm will always produce the same hash value), fixed length (e.g., the hash value has a fixed size, regardless of the input message's length), and/or unique (e.g., a hashing algorithm may produce unique hash values for different input messages). In some embodiments, the system may use hashing algorithms, such as SHA-256 (Secure Hash Algorithm 256-bit), MD5 (Message Digest Algorithm 5), and bcrypt.

The system may then partition the data, whereby the message is divided into smaller blocks or chunks. The size of these blocks depends on the hashing algorithm being used. The algorithm processes each block of data in a specific manner. It performs a series of calculations and transformations on the data to create a unique representation. The system then processes each block. As the processing steps are applied to each block, the algorithm continuously compresses the data. This compression reduces the size of the data and ensures that the hash value remains a fixed length, regardless of the input message's size. In some embodiments, the processing steps are repeated multiple times. Each iteration takes the output of the previous step and feeds it back into the algorithm for further processing. This iteration adds an additional layer of complexity and security to the hashing process. Once all the blocks have been processed, the system performs a final set of operations to generate the hash value. These operations typically involve combining the results of the previous steps in a specific way to produce the final hash.

In some embodiments, prior to generating the first hash and/or committing the first hash to the blockchain, the system may confirm that a user has requested specific computing resources (and/or paid a premium in an insurance embodiment). For example, generating the first hash based on the first event may comprise the system receiving a first computing resource request and confirming receipt of the first computing request.

At step 508, process 500 (e.g., using one or more components described above) determines a total resource requirement. For example, the system may determine a total resource requirement for the time period by aggregating respective resource requirements for a plurality of events corresponding to the time period. In some embodiments, the system may retrieve a plurality of hashes to determine other resource requirements.

At step 510, process 500 (e.g., using one or more components described above) determines a probability of a parametric event. For example, the system may determine a probability of a parametric event based on the first resource requirement of the total resource requirement. For example, determining the total resource requirement for the time period by aggregating respective resource requirements for the plurality of events corresponding to the time period may comprise receiving a plurality of hashes corresponding to the plurality of events and determining the respective resource requirements based on the plurality of hashes. In some embodiments, the system may rely on information available on one or more blockchain networks to determine other resource requirements. For example, the system may rely on information available on one or more blockchain networks to determine other resource requirements. For example, the system may receive a first hash of the plurality of hashes from a first blockchain network. The system may receive a second hash of the plurality of hashes from a second blockchain network.

The system may determine the threshold probability to be specific to the first event (e.g., based on event data of the first event). For example, the system may receive a first event data corresponding to the first event. The system may determine the threshold probability based on the first event data. Alternatively or additionally, the system may retrieve third-party data and generate a computing resource score based on the third-party data and the probability.

At step 512, process 500 (e.g., using one or more components described above) generates a notification based on the probability. For example, the system may generate for display the notification at a location in the user interface based on the time period. For example, the system may compare the probability to a threshold probability. The system may determine to generate a notification based on comparing the probability to a threshold probability. The system may generate for display the notification at a location in the user interface based on the time period.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for computing resources between different cloud computing systems.
2. The method of the embodiment above, wherein the method comprises: receiving, via a user interface, a first user input, wherein the first user input schedules a first event; determining a time period corresponding to the first event; receiving a second user input, wherein the second user input indicates first resource requirement for the first event; determining a total resource requirement for the time period by aggregating respective resource requirements for a plurality of events corresponding to the time period; determining a probability of a parametric event based on the first resource requirement of the total resource requirement; comparing the probability to a threshold probability; determining to generate a notification based on comparing the probability to a threshold probability; and generating for display the notification at a location in the user interface based on the time period.
3 The method of any one of the preceding embodiments, wherein receiving, via the user interface, the first user input, further comprises: generating for display a scheduling graphic in the user interface, wherein the scheduling graphic comprises a plurality of time periods; and receiving a third user input, wherein the third user input comprises first event data, wherein the time period corresponding to the first event is based on the first event data.
4. The method of any one of the preceding embodiments, further comprising: generating a first hash based on the first event; and recording the first hash on a first blockchain.
5. The method of any one of the preceding embodiments, wherein generating the first hash based on the first event further comprises: receiving a first computing resource request; and confirming receipt of the first computing request.
6. The method of any one of the preceding embodiments, wherein determining the total resource requirement for the time period by aggregating respective resource requirements for the plurality of events corresponding to the time period further comprises: receiving a plurality of hashes corresponding to the plurality of events; and determining the respective resource requirements based on the plurality of hashes.
7. The method of any one of the preceding embodiments, wherein receiving the plurality of hashes corresponding to the plurality of events further comprises: receiving a first hash of the plurality of hashes from a first blockchain network; and receiving a second hash of the plurality of hashes from a second blockchain network.
8 The method of any one of the preceding embodiments, wherein receiving the first hash of the plurality of hashes from the first blockchain network further comprises: determining an encryption for the first hash; and decrypting the first hash based on the encryption.
9. The method of any one of the preceding embodiments, further comprising: receiving a second event of a plurality of events; determining a first taxonomy for the second event; and determining second event data based on the first taxonomy.
10. The method of any one of the preceding embodiments, further comprising: determining a second taxonomy for the second event, wherein the second taxonomy is a standardized taxonomy; and reformatting second event data based on the second taxonomy.
11. The method of any one of the preceding embodiments, further comprising: receiving a plurality of events corresponding to the time period; determining respective resource requirements based on the plurality of events; and determining the threshold probability based on the respective resource requirements.
12. The method of any one of the preceding embodiments, further comprising: receiving a plurality of events corresponding to the time period; determining respective resource requirements based on the plurality of events; and determining the threshold probability based on the respective resource requirements.
13. The method of any one of the preceding embodiments, further comprising: receiving a first event data corresponding to the first event; and determining the threshold probability based on the first event data.
14. The method of any one of the preceding embodiments, further comprising: retrieving third-party data; and generating a computing resource score based on the third-party data and the probability.
15. A tangible, non-transitory, machine-readable medium storing instructions that, when executed by a data processing apparatus, cause the data processing apparatus to perform operations comprising those of any of embodiments 1-14.
16. A system comprising one or more processors; and memory storing instructions that, when executed by the processors, cause the processors to effectuate operations comprising those of any of embodiments 1-14.
17. A system comprising means for performing any of embodiments 1-14.

What is claimed:

1. A system for computing resources between different cloud computing systems, the system comprising:
one or more processors; and
one or more non-transitory, computer-readable mediums comprising instructions recorded thereon that when executed by the one or more processors cause operations comprising:
receiving, via a user interface, a first user input, wherein the first user input schedules a first event corresponding to use of first computing resources for a first cloud computing system;
determining a time period corresponding to the first event;
receiving a second user input, wherein the second user input indicates first resource requirement for the first event, wherein the first resource requirement is defined by a metric, and wherein the metric is based on availability, response time, channel capacity, latency, completion time, service time, bandwidth, throughput, relative efficiency, scalability, performance per watt, compression ratio, and/or instruction path length;
generating a first hash based on the first event;
recording the first hash on a first blockchain;
receiving, from the first blockchain, respective resource requirements for a plurality of events corresponding to the time period, and wherein each of the plurality of events corresponds to one of a plurality of cloud computing systems;
determining a total resource requirement for the time period by aggregating the respective resource requirements;
determining, using a first self-executing program, a probability of a parametric event based on the first resource requirement of the total resource requirement;
comparing, using a second self-executing program, the probability to a threshold probability;
determining to generate a notification based on comparing the probability to a threshold probability; and
generating for display the notification at a location in the user interface based on the time period.

2. A method for computing resources between different cloud computing systems, the method comprising:
receiving, via a user interface, a first user input, wherein the first user input schedules a first event;
determining a time period corresponding to the first event;
receiving a second user input, wherein the second user input indicates first resource requirement for the first event;
determining a total resource requirement for the time period by aggregating respective resource requirements for a plurality of events corresponding to the time period;
determining a probability of a parametric event based on the first resource requirement of the total resource requirement;
comparing the probability to a threshold probability;
determining to generate a notification based on comparing the probability to a threshold probability; and
generating for display the notification at a location in the user interface based on the time period.

3. The method of claim 2, wherein receiving, via the user interface, the first user input, further comprises:
generating for display a scheduling graphic in the user interface, wherein the scheduling graphic comprises a plurality of time periods; and
receiving a third user input, wherein the third user input comprises first event data, wherein the time period corresponding to the first event is based on the first event data.

4. The method of claim 2, further comprising:
generating a first hash based on the first event; and
recording the first hash on a first blockchain.

5. The method of claim 4, wherein generating the first hash based on the first event further comprises:
receiving a first computing resource request; and
confirming receipt of the first computing resource request.

6. The method of claim 2, wherein determining the total resource requirement for the time period by aggregating respective resource requirements for the plurality of events corresponding to the time period further comprises:
receiving a plurality of hashes corresponding to the plurality of events; and
determining the respective resource requirements based on the plurality of hashes.

7. The method of claim 6, wherein receiving the plurality of hashes corresponding to the plurality of events further comprises:
receiving a first hash of the plurality of hashes from a first blockchain network; and
receiving a second hash of the plurality of hashes from a second blockchain network.

8. The method of claim 7, wherein receiving the first hash of the plurality of hashes from the first blockchain network further comprises:
determining an encryption for the first hash; and
decrypting the first hash based on the encryption.

9. The method of claim 2, further comprising:
receiving a second event of a plurality of events;
determining a first taxonomy for the second event; and
determining second event data based on the first taxonomy.

10. The method of claim 9, further comprising:
determining a second taxonomy for the second event, wherein the second taxonomy is a standardized taxonomy; and
reformatting second event data based on the second taxonomy.

11. The method of claim 2, further comprising:
receiving a plurality of events corresponding to the time period;
determining respective resource requirements based on the plurality of events; and
determining the threshold probability based on the respective resource requirements.

12. The method of claim 2, further comprising:
receiving a plurality of events corresponding to the time period;
determining respective resource requirements based on the plurality of events; and
determining the threshold probability based on the respective resource requirements.

13. The method of claim 2, further comprising:
receiving a first event data corresponding to the first event; and
determining the threshold probability based on the first event data.

14. The method of claim 2, further comprising:
retrieving third-party data; and
generating a computing resource score based on the third-party data and the probability.

15. One or more non-transitory, computer-readable media, comprising instructions that, when executed by one or more processors, cause operations comprising:
determining a time period corresponding to a first event, wherein the first event corresponds to a first resource requirement;
determining a total resource requirement for the time period by aggregating respective resource requirements for a plurality of events corresponding to the time period;
determining a probability of a parametric event based on the first resource requirement of the total resource requirement;
comparing the probability to a threshold probability;
determining to generate a notification based on comparing the probability to a threshold probability; and
generating for display the notification at a location in a user interface based on the time period.

16. The one or more non-transitory, computer-readable media of claim 15, wherein the instructions further cause operations comprising:
generating for display a scheduling graphic in the user interface, wherein the scheduling graphic comprises a plurality of time periods;
receiving a user input, wherein the user input comprises first event data, wherein the time period corresponding to the first event is based on the first event data.

17. The one or more non-transitory, computer-readable media of claim 15, wherein the instructions further cause operations comprising:
generating a first hash based on the first event; and
recording the first hash on a first blockchain.

18. The one or more non-transitory, computer-readable media of claim 17, wherein generating the first hash based on the first event further comprises:
receiving a first computing resource request; and
confirming receipt of the first computing resource request.

19. The one or more non-transitory, computer-readable media of claim 15, wherein determining the total resource requirement for the time period by aggregating respective resource requirements for the plurality of events corresponding to the time period further comprises:
receiving a plurality of hashes corresponding to the plurality of events; and
determining the respective resource requirements based on the plurality of hashes.

20. The one or more non-transitory, computer-readable media of claim 19, wherein the plurality of hashes corresponding to the plurality of events further comprises:
determining an encryption for a first hash; and
decrypting the first hash based on the encryption.
